(19) United States
(12) Patent Application Publication
(10) Pub. No.: US 2024/0351028 A1
(43) Pub. Date: Oct. 24, 2024

(54) MICRO-FLUIDIC DEVICE AND MICRO-FLUIDIC MEASURING ARRANGEMENT

(71) Applicant: ams International AG, Jona (CH)

(72) Inventor: Erik Jan LOUS, Veldhoven (NL)

(21) Appl. No.: 18/577,303

(22) PCT Filed: Jun. 14, 2022
(86) PCT No.: PCT/EP2022/066084

§ 371 Date: Jan. 8, 2024

(30) Foreign Application Priority Data
Jul. 8, 2021 (DE) 10 2021 117 672.7

(51) Int. Cl. B01L 3/00; B01L 7/00; G01N 1/44; G01N 21/01

(52) U.S. Cl. CPC B01L 3/502715; B01L 7/00; G01N 1/44; G01N 21/01; B01L 2200/025; B01L 2200/04; B01L 2300/0654; B01L 2300/1822

(57) ABSTRACT

A micro-fluidic device includes an integrated photodetector circuit. The integrated photodetector circuit includes at least one photodetector. The micro-fluidic device also includes a micro-fluidic cartridge. The micro-fluidic cartridge includes at least one detection chamber connected to a micro-channel to receive a liquid to be tested. The micro-fluidic cartridge is arranged on the integrated photodetector circuit such that the at least one detection chamber is aligned with the photodetector. The micro-fluidic device further includes a heating element thermally conductive to the detection chamber and operable to alter a temperature of the liquid to be tested. The micro-fluidic device additionally includes a cooling element thermally conductive to the photodetector and operable to alter a temperature of the photodetector.

### FIELD OF DISCLOSURE

The present disclosure relates to a micro-fluidic device and to a micro-fluidic measuring arrangement.

### BACKGROUND

Design of micro-fluidic cartridges plays a key role in the successful development of a diagnostic systems where ease of use, throughput, and cost per test are critical factors. This is particularly true for Point of Care Testing (or POCT for short) applications in which the cartridge also acts as an easy and intuitive user hardware interface.

At low signal intensities, like for photon counting, as used in the most sensitive bio-diagnostic reactions, a close vicinity integration may be important as light intensities drops of with 1/R², where R is the distance between a sample in a micro-fluidic cartridge and a detector. It is common in the art, however, to rely on an integration with loose, large scale components, e.g. with diodes or ASICs at a distance from each other, with optical components (lenses, optical filters, . . . ) in between, such that the cartridge can be removed. Sometimes, ASICs are placed on a side of the micro-fluidic cartridge, where metal traces are also present.

In digital health to enable sensitive disposable point-of-care solutions, cost-effective test are needed at around 37 degrees Celsius, room temperature and at photon counting sensitivities. For this, a photon counting sensor, including single-photon avalanche diodes, is assembled together with a micro-fluidic cartridge for detecting bio-diagnostic events via luminescence or fluorescence. A defined temperature may be achieved by heaters. Cooling of the photon counting sensor may be achieved by dedicated cooling elements. For example, cooling of a sense SPAD to around −30° C. will enable about two orders lower noise count compared to room temperature. This will allow the most sensitive tests available in the bio-diagnostic lab to bring to miniaturized Point-of-Care setting. Solutions known in the art typically employ separate heating or cooling in a very bulky manner not suited to miniaturize cost-effectively in a small package. For heat transfer in the micro-fluidics often a liquid is used to heat or cool. Wiring heating in micro-fluidics has been reported, but not small and not in combinations with small size cooling.

It is an object of the present disclosure to provide a micro-fluidic system, including detection, which allows for heating and cooling in a miniaturized cost-effective package.

These objects are achieved by the subject-matter of the independent claims. Further developments and embodiments are described in the dependent claims.

It is to be understood that any feature described in relation to any one embodiment may be used alone, or in combination with other features described herein, and may also be used in combination with one or more features of any other of the embodiments, or any combination of any other of the embodiments unless described as an alternative. Furthermore, equivalents and modifications not described below may also be employed without departing from the scope of the micro-fluidic device and to a micro-fluidic measuring arrangement which are defined in the accompanying claims.

### SUMMARY

The following relates to an improved concept in the field of micro-fluidics. One aspect relates to close integration of an integrated photodetector circuit and micro-fluidics, e.g. comprising light emitting chemistry and a micro-fluidic cartridge. Another aspect relates to combining heating and cooling in a single micro-fluidic device, e.g. for use in Point of Care Testing. Further aspects relate to an integrated photodetector circuit, such as an ASIC, with one or more photodetectors and a micro-fluidic cartridge which can be arranged on the photodetector circuit to enable single or multiple measurement channels.

Furthermore, a heating element may be integrated in a flex foil, e.g. as electrical wiring integrated on the same flex foil as where the integrated photodetector circuit and/or driver circuit are bonded to. This can be the same flex foil as the closing foil of the micro-fluidic cartridge. Alternatively, electrical wiring may be integrated on a same carrier, such as PCB or laminate, where the integrated photodetector circuit and/or driver circuit are bonded. Ultimately, heater coils can be integrated, e.g. made from Tungsten, on the integrated photodetector circuit, e.g. on top of an integrated heat barrier or at the side of the microfluidic cartridge.

A cooling element may be implemented as a Peltier cooler. The cooling element may be mounted directly underneath the integrated photodetector circuit. The Peltier or cooling element may be driven by separate connections or connections to a foil or carrier. As a further option, an integrated vacuum layer (or chamber) may act as heat barrier on top of the sensor area of the integrated photodetector circuit, in between the micro-fluidic detection chamber.

In at least one embodiment a micro-fluidic device comprises an integrated photodetector circuit, a micro-fluidic cartridge, a heating element and a cooling element.

The integrated photodetector circuit comprises at least one photodetector. For example, the photodetector may be implemented as a photodiode, such as a single photon avalanche diode.

The micro-fluidic cartridge comprises at least one detection chamber which is connected to a micro-channel. The micro-fluidic cartridge is arranged on the integrated photodetector circuit such that the at least one detection chamber is aligned with the photodetector.

The heating element is thermally conductive to the detection chamber. The cooling element is thermally conducive to the photodetector.

During operation the micro-fluidic cartridge receives the liquid to be tested, e.g. via the micro-channel. The liquid may be applied to the detection chamber via the connected micro-channel. The photodetector may detect a light signal, such as fluorescence or chemo-luminescence, from the liquid to be tested which is present in the detection chamber. Furthermore, the heating element alters or sets a temperature of the liquid to be tested. For example, the heating element may set the temperature of the liquid in the detection chamber to room temperature or an elevated temperature, such as 37° C. (or a body temperature). The cooling element, however, alters a temperature, or operating temperature, of the photodetector(s). For example, during operation of the micro-fluidic device the cooling element cools the photodetector via its thermal conductive connection to allow for reduced operating temperature.

Cooling of a photodetector, e.g. to ˜−30° C., may achieve a considerable lower noise level and sensitivity equivalent to the most sensitive tests in the clinical laboratories. At the same time measurements of the liquids in the detection chambers can be conducted at elevated temperatures, such as 37° C. or any other desired temperature, instead off, or in addition to, only room temperature. On other words, the combination of heating and cooling elements in the same device allows ultra-high sensitive measurements by enabling ultra-low dark count measurements.

Integration of (small sized) cooling elements, such as a Peltier cooler, in or on the integrated photodetector circuit, may not affect the micro-fluidic sample, which stays at room temperature or elevated temperature, e.g. 37° C. These features can be integrated into a single device in a cost-effective manner. Point-of-care (PoC) applications benefit from the improved concept. Due to the lower price components of the micro-fluidic device can be disposable and open access to mass production.

On the contrary, in prior art solutions, if any measure is taken with heating and/or cooling, solutions remains bulky, not cost effective or not suited for small form factor PoC applications. The proposed concept also solves the challenge of close-proximity and cost-effectively integrate this, while the micro-fluidic sense well is kept at room temperature or higher. To enable this heating and cooling are possible simultaneously.

In at least one embodiment the micro-fluidic cartridge comprises multiple detection chambers. The detection chambers are connected to respective micro channels to receive a liquid to be tested. Furthermore, the micro-fluidic cartridge is arranged on the integrated photodetector circuit such that detection chambers are aligned with the photodetectors.

The micro-fluidic cartridge can be considered a multiple channel cartridge which allows to test and receive not only a single liquid, but either a higher amount of one liquid or several liquids to be tested. Due to the alignment of the photodetectors with respective detection chambers, the photodetectors may operate in parallel to record light signals such as fluorescence or luminescence from the respective liquids. The micro-fluidic cartridge may have detection chambers in different levels to allow for even further liquids to be tested in parallel.

In at least one embodiment the integrated photodetector circuit is arranged on and electrically connected to a flexible foil. For example, the flexible foil comprises electrical connections to connect the integrated photodetector circuit to further components, such as a driver circuit, or provides an interface to external components, such as a computer or reader device.

In at least one embodiment the flexible foil is arranged on the micro-fluidic cartridge. Furthermore, the flexible foil seals the micro-fluidic cartridge.

In at least one embodiment the integrated photodetector circuit is arranged on and electrically connected to a carrier. For example, the carrier comprises a printed circuit board and/or a laminate.

In at least one embodiment the micro-fluidic device further comprises an integrated driver circuit. The integrated driver circuit is electrically connected to the integrated photodetector circuit. During operation, the integrated driver circuit controls the micro-fluidic cartridge and/or the integrated photodetector circuit.

In at least one embodiment the integrated driver circuit and the integrated photodetector circuit are commonly arranged on and/or electrically connected to the flexible foil or to the carrier.

In at least one embodiment the heating element is arranged, in thermal contact, on a surface of the integrated photodetector circuit. Alternatively, the heating element is integrated into the integrated photodetector circuit. The heating element may alter a temperature of a liquid in the detection chamber(s). This allows to create and maintain a controlled temperature, e.g. for desired chemical reactions to take place in the detection chambers to take place.

Alternatively, the heating element is arranged, in thermal contact, on a surface of or in the microfluidic cartridge, near the microfluidic detection chamber.

In at least one embodiment the heating element comprises heater coils. The coils may be integrated or wrapped around the micro-fluidic cartridge.

In at least one embodiment the cooling element is arranged, in thermal contact, on a surface of the integrated photodetector circuit. Alternatively, the cooling element is integrated into the integrated photodetector circuit. The cooling element may alter an operating temperature of photodetectors, in order to reduce noise. For SPADs this is the dark count rate.

In at least one embodiment the cooling element comprises a Peltier element.

In at least one embodiment the micro-fluidic device further comprises an integrated heat barrier, which can be a vacuum layer, which may act as a heat barrier for one or more of the photodetectors. There may be one or more integrated heat barriers.

In at least one embodiment the micro-fluidic device further comprises a cooling temperature sensor which is integrated into the integrated photodetector circuit. In addition, or alternatively, the cooling temperature sensor is operable to measure a temperature in a depletion zone, e.g. of some blinded photodetectors to measure a dark current of these blinded photodetectors, simultaneously.

In at least one embodiment the micro-fluidic device further comprises a heater temperature sensor which is integrated into the integrated photodetector circuit. In addition, or alternatively, the heater temperature sensor is operable to measure a coil resistance as a function of temperature of the heating element. Or, the heater temperature sensor comprises heat sensor elements which are operable to provide a temperature-dependent signal.

In at least one embodiment a micro-fluidic measuring arrangement comprises a micro-fluidic device according to one of the aspects discussed above. Furthermore, the micro-fluidic measuring device comprises a reader device. For example, the reader device comprises an opening to insert the micro-fluidic cartridge into a measurement position.

The micro-fluidic measuring device can be implemented to conduct a fluorescence based measurement or a chemo-luminescence based measurement. For the first type of measurement, the reader may be equipped with an excitation light source to illuminate the one or more detection chambers and/or a processing unit to control the light source. This way, the photodetectors may record fluorescence returning from the liquid in the detection chambers. In such case the photodetectors are equipped with the required optical filter arrangement to block the excitation light wavelength and detect the fluorescent wavelength.

For the second type of measurement, the reader does not necessarily need to be equipped with a light source as no excitation may be needed to initiate luminescence. However, the micro-fluidic cartridge, i.e. micro-channels, can be used to insert chemical compounds to trigger chemical reactions, which yield a chemo-luminescent response. These may already be present in the freeze-dried chemistry in the micro-fluidic detection chamber (or before in the microfluidic system/channels). Triggering occurs then by adding sample-liquid (e.g. urine, saliva, blood) from outside the cartridge. This may be controlled and/or processed by the processing unit. The reader device may be equipped to conduct one or both of the measurements discussed above.

The micro-fluidic measuring arrangement can be made with a small form factor and at considerable low cost. The arrangement allows to conduct highly accurate testing of bio-parameters by a medical practitioner rather than a highly specialised lab. This may also reduce response times in medical testing.

The following description of figures of example embodiments may further illustrate and explain aspects of the improved concept. Components and parts with the same structure and the same effect, respectively, appear with equivalent reference symbols. Insofar as components and parts correspond to one another in terms of their function in different figures, the description thereof is not necessarily repeated for each of the following figures.

### BRIEF DESCRIPTION OF THE DRAWINGS

In the Figures:

FIG. 1A shows an example embodiment of a micro-fluidic device,

FIG. 1B shows an example embodiment of a micro-fluidic device in top view,

FIG. 2 shows another example embodiment of a micro-fluidic device,

FIG. 3 shows another example embodiment of a micro-fluidic device,

FIG. 4 shows another example embodiment of a micro-fluidic device,

FIG. 5 shows another example embodiment of a micro-fluidic device, and

FIG. 6A, 6B show example embodiments of a micro-fluidic measuring arrangement.

### DETAILED DESCRIPTION

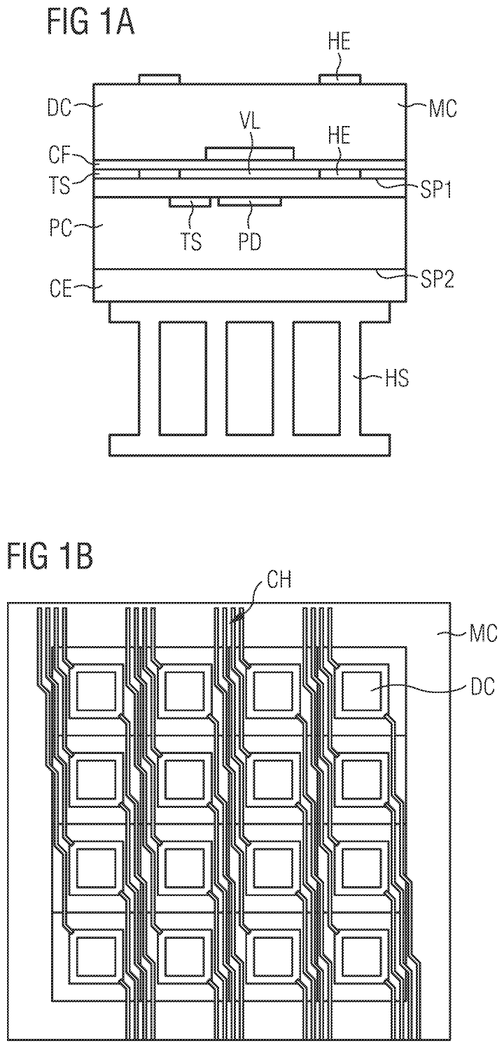

FIG. 1A shows an example embodiment of a micro-fluidic device. The micro-fluidic device comprises an integrated photodetector circuit PC, a micro-fluidic cartridge MC and both a heating element HE and a cooling element CE.

The integrated photodetector circuit PC is implemented as an ASIC with one or more photodetectors integrated in a common integrated circuit. The number of photodetectors translates into a number of measurements which can be conducted in parallel. Typically, the photodetectors are photodiodes, such as single photon avalanche photodiodes which provide highly sensitive (photon counting) detection.

The micro-fluidic cartridge MC comprises one or more detection chambers DC, which are arranged into a cartridge body. The cartridge body may be a glass, plastic or mold of transparent or opaque mold material, or a combination of both. The micro-fluidic cartridge comprises a single detection chamber (single channel) to allow for a measurement at a time or a number of detection chambers (multiple channels) to allow for a number of measurements which can be conducted in parallel. In fact, the micro-fluidic cartridge is arranged on the integrated photodetector circuit such that a detection chamber is aligned with a dedicated photodetector.

The micro-fluidic cartridge further comprises a number of micro-channels CH, which are also arranged into a cartridge body. The micro-channels connect the detection chambers in order to input a liquid to be tested. For example, there may be a dedicated micro-channel for each detection chamber in order to supply the detection chambers individually with a liquid to be tested. However, a number of detection chambers may also share a common micro-channel so that these are supplied with a same liquid to be tested. Or leading out to the same waste liquid chamber.

The detection chambers DC may be implemented into the cartridge body in different ways. In this example, the detection chamber depicted in the drawing remains open to the environment, i.e. forms an opening or recess in the cartridge body. The micro-fluidic cartridge can be sealed from the environment by means of closing film CF. The closing film is arranged on a surface of the cartridge body facing the integrated photodetector circuit PC. This way, the photodetectors are not in direct contact with the liquid to be tested.

In other embodiments the detection chambers may be implemented as cavities which are enclosed by the cartridge body. The detection chambers may only be accessed via the micro-channels. A closing film may not be necessary in this case. In yet other embodiments the detection chambers forms an opening or recess in the cartridge body but there is no closing film, or the like. This way, the photodetectors are in direct contact with the liquid to be tested and effectively closing off the detection chambers.

The heating element HE is arranged to be in thermal contact with the single detection chamber DC (single channel) or with a number of detection chambers (multiple channels). Due to the thermal contact the heating element may conduct heat to one or more of the detection chambers and may alter a temperature of a liquid to be tested, which may be present in the detection chambers. This way, the liquid in a detection chamber may be heated to a desired temperature, or a said temperature can be held constant for a duration of one or consecutive measurements in order to set a reference condition. For example, the liquid can be set to room temperature or 37° C. to mimic a body temperature. The heating element can be electrically connected to the integrated circuit and/or to a driver circuit.

The heating element HE in this embodiment is integrated on a surface SP1 of the integrated photodetector circuit PC facing the micro-fluidic cartridge MC. Here, the heating element is arranged between the integrated photodetector circuit and the micro-fluidic cartridge and is in contact with the closing film CF. As an option, there may be an integrated vacuum layer VL (or vacuum chamber) arranged on the surface SP1 of the integrated photodetector circuit as well. Here, the heating element flanks the vacuum layer. Alternatively, the heating element HE can also be placed on top of the vacuum layer VL. The integrated vacuum layer acts as heat barrier on top of the photodetectors of the integrated photodetector circuit.

In other embodiments the heating element may be integrated on a foil, a carrier (such as a printed circuit board or a laminate), directly on top of the micro-fluidic chamber MC, or others.

A heater temperature sensor can be implemented in different ways. For example, the sensor measures a coil resistance as a function of temperature of the heating element HE. Alternatively, the heater temperature sensor comprises heat sensor elements, such as MEMS elements, a thermocouple or Pt100 element, which provide a temperature dependent signal.

The cooling element CE is arranged, in thermal contact, on another surface SP2 of the integrated photodetector circuit PD. The cooling element may also be integrated into the integrated photodetector circuit. In this embodiment the cooling element is mounted directly underneath the integrated photodetector circuit. The cooling element can be electrically connected to the integrated photodetector circuit, a foil, a carrier (such as a printed circuit board or a laminate), or others. The electrical connection is used to drive the cooling element, for example.

The cooling element can be implemented as a Peltier element. The Peltier element is arranged with its cool side on the surface SP2 of the integrated photodetector circuit. The hot side of the Peltier element is facing away and connected to a heat sink HS to dissipate any heat away from the micro-fluidic device.

A cooling temperature sensor TS is integrated into the integrated photodetector circuit PC. The cooling temperature sensor measures a temperature on the cooling side (e.g. of a depletion zone of a photodetector or can alternatively, to further simplify design, also be measured by dark current of the photodetectors or some blinded SPADs.

Both cooling and heating element can be driven by a driver circuit (not shown). Temperature regulations (or algorithm) are driven by this or a separate controller. Alternatively, the integrated photodetector circuit may comprise an integrated controller, which controls operation of the photodetectors and/or heater and cooling element.

FIG. 1B shows an example embodiment of a micro-fluidic device in top view. This example shows a micro-fluidic cartridge with a number of detection chambers (multiple channels) are arranged in an array. Each of the detection chambers is connected to a dedicated micro-channel CH to receive their respective liquid to be tested.

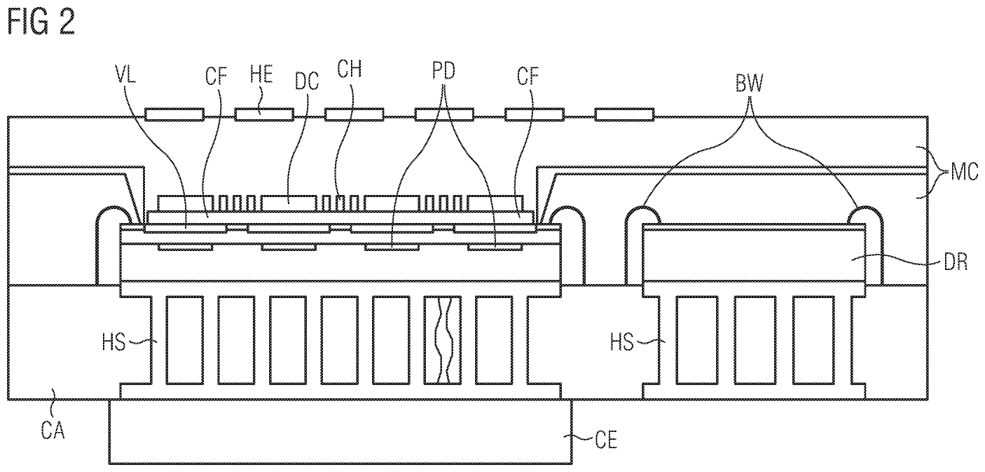

FIG. 2 shows another example embodiment of a micro-fluidic device. This embodiment is a further development of the one shown above in FIG. 1. In the following some aspects are highlighted, while others are not discussed in detail again, but may be present nonetheless. This embodiment constitutes a two chip solution with embedded micro-fluidic cartridge.

The micro-fluidic device is based on a carrier CA. For example, the carrier comprises a printed circuit board or polyimide laminate. Furthermore, two heat sinks are integrated into the carrier. In fact, there are two heat sinks arranged in the carrier. The integrated photodetector circuit is arranged on the carrier and, in thermal contact, on a first heat sink. In addition, the micro-fluidic device comprises an integrated driver circuit which is arranged on the carrier and, in thermal contact, on a second heat sink. Both the integrated photodetector circuit and the integrated driver circuit are electrically connected to the carrier via bond wires BW.

The integrated photodetector circuit comprises a number of photodetectors, e.g. which are arranged in a frontend FE of the CMOS ASIC. The photodetectors are represented by their depletion zones. For example, the photodetectors are implemented as a SPAD which are arranged in an array. A backend BE of the integrated photodetector circuit comprises an integrated vacuum layer VL. The vacuum layer comprises a number of vacuum chambers which are arranged above and aligned with the photodetectors. This way, the vacuum chambers act as heat barriers for the photodetectors. Note, it can also be made as one vacuum chamber VL covering multiple PD's.

The cooling element CE is arranged, in thermal contact, on the surface SP2 of the integrated photodetector circuit PC. The cooling element is mounted directly underneath the integrated photodetector circuit. In this embodiment the cooling element is implemented by a Peltier element, with its cooling side mounted to the integrated photodetector circuit. In a lateral dimension the Peltier element is similar in size than the integrated photodetector circuit. Thus, a small Peltier element may suffice to cool all photodetectors in the integrated photodetector circuit. The heat sink further supports efficient heat transfer to and away from the integrated photodetector circuit. The heat sinks can be implemented as vias in the carrier, for example.

The heating element HE can be arranged between the micro-fluidic cartridge and the integrated photodetector circuit or on top of the micro-fluidic cartridge (as shown in FIG. 2). The heating element may span over the surface of the integrated photodetector circuit and may be arranged on the integrated vacuum layer VL. This way, the heating element is between the micro-fluidic cartridge MC and the integrated photodetector circuit PC. Alternatively, the heating element may be implemented as a coil on a flex foil between the micro-fluidic cartridge MC and the integrated photodetector circuit PC. Further alternatives, or additions, include a heating element integrated in the integrated photodetector circuit or in the carrier.

The micro-fluidic cartridge MC is arranged on the carrier, photodetector circuit and driver circuit. One section of the cartridge encloses the carrier, photodetector circuit and driver circuit. Both the driver circuit and the photodetector circuit may be covered with an additional plastic foil which acts as a heat barrier to the cartridge body. The cartridge body may be a glass, plastic, a foil or mold of transparent or opaque mold material, or a combination of these. In this embodiment the cartridge body comprises opaque material to reduce optical crosstalk.

Detection chambers DC and micro-fluidic channels CH are arranged in another section of the cartridge. With this section the micro-fluidic cartridge is arranged on the integrated photodetector circuit such that a detection chambers are aligned with the photodetectors. The micro-fluidic cartridge comprises a gap, which is arranged between the sections of the cartridge body to act as a heat barrier. The micro-fluidic cartridge can be implemented as a two piece element, i.e. the two sections are separate. Or micro-fluidic cartridge can be implemented as a single piece element, i.e. the two sections are arranged in a contiguous cartridge body.

The integrated driver circuit controls operation of the integrated photodetector circuit. Furthermore, both cooling and heating element can be driven by the driver circuit to set or regulate a temperature with said elements.

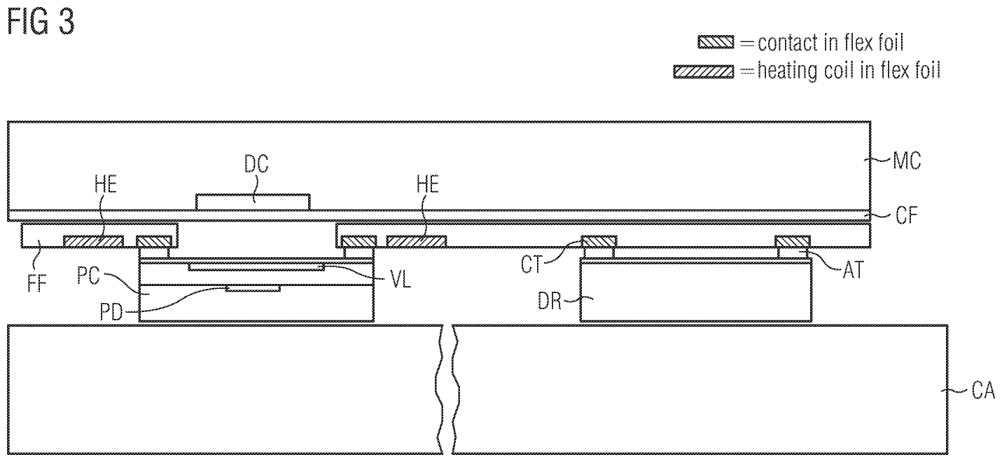

FIG. 3 shows another example embodiment of a micro-fluidic device. This embodiment is a further development of the one shown above in FIGS. 1 and 2. In the following some aspects are highlighted, while others are not discussed in detail again, but may be present nonetheless. This embodiment constitutes a two chip solution with a flex-foil integration of a heating element and heat transfer barrier. This provide an option for a double sided flex foil, with heating on one side (or two separate flex foils), or a one-sided flex foil as depicted. In the latter case a closing film CF closes off or seals the detection chambers and micro-channels.

In this embodiment the micro-fluidic cartridge comprises multiple detection chambers or a single detection chamber as depicted as well as single or multiple channels. The micro-fluidic cartridge is closed by means of a closing foil. For easier representation the carrier is shown without heat sink and cooling element.

The heating element HE is arranged in a flex foil FF. For example, the heating element comprises a heating coil. The flex foil is arranged on the micro-fluidic cartridge, i.e. at a surface of the cartridge body. Furthermore, the flex foil is attached to the integrated photodetector circuit and driver circuit via an anisotropic conducting tape and contacts CT arranged in the foil. The foil comprises a number of cutouts, which align with the photodetectors. When mounted to the carrier, the cutouts define cavities aligned with the photodetectors and detection chambers. In this example, there may be no further package, such as a mold structure, as depicted. In a further development of this embodiment, however, there may be mold structure which encloses the integrated photodetector circuit and/or the driver circuit.

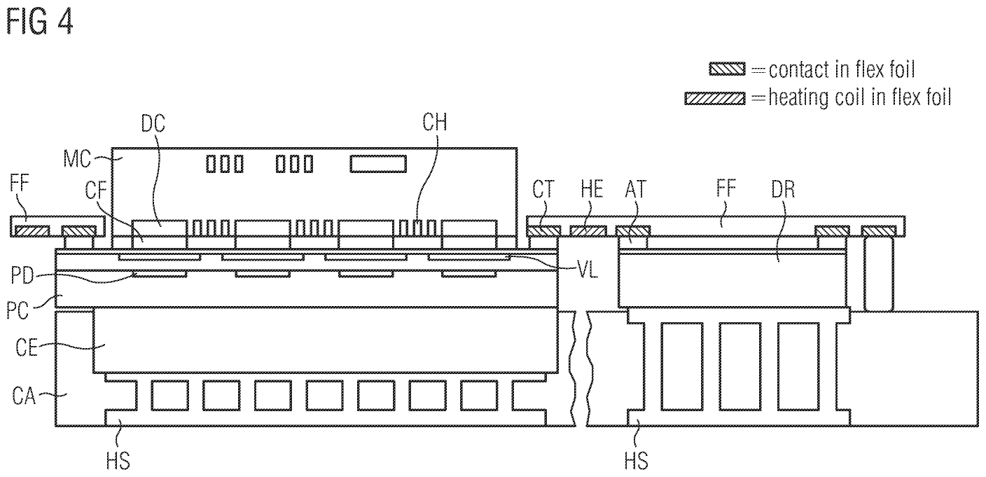

FIG. 4 shows another example embodiment of a micro-fluidic device. This embodiment is a further development of the one shown above in pervious Figures. In the following some aspects are highlighted, while others are not discussed in detail again, but may be present nonetheless. This embodiment constitutes a two chip solution with a flex-foil integration. The cartridge is arranged in the gap of a flex foil.

In this embodiment the micro-fluidic cartridge MC comprises an opaque material to reduce crosstalk. The micro-fluidic cartridge is arranged on the integrated photodetector circuit only. The driver circuit has no direct contact with the micro-fluidic cartridge. Instead the flex foil is arranged on the driver circuit rather than the integrated photodetector circuit. In fact, the micro-fluidic cartridge is arranged in a gap of the flex foil for the detection part. Other parts of the micro-fluidic cartridge MC may extend outside the boundaries of the FF.

The heating element HE is arranged in the flex foil FF. The foil may be single or double layered to implement the heating element. For example, the heating element comprises a heating coil. The flex foil is arranged on the micro-fluidic cartridge, i.e. at a surface of the cartridge body. Furthermore, the flex foil is attached to the integrated photodetector circuit outside the gap and to the driver circuit via anisotropic conducting tape and contacts CT arranged in the foil. Cavities are formed and aligned with the photodetectors and detection chambers. The micro-fluidic cartridge MC is sealed with an integrated closing film CF, with patterning of opaque areas and optical windows. Furthermore, the micro-fluidic cartridge may have additional detection chambers which are arranged in the cartridge body at different heights. Those additional detection chambers are accompanied by respective micro-fluidic channels. Another option is to arrange the cooling element between a heat sink and the photodetector circuit.

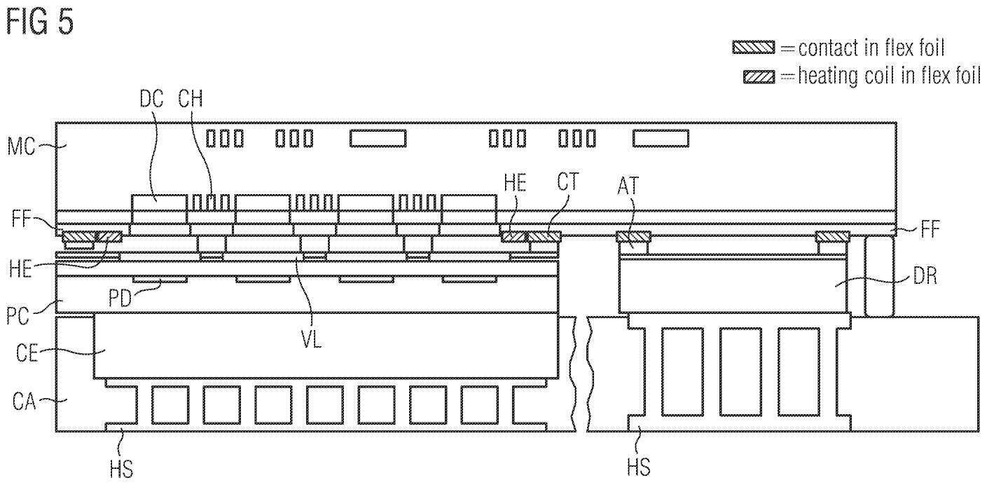

FIG. 5 shows another example embodiment of a micro-fluidic device. This embodiment is a further development of the one shown above in FIGS. 4. In the following some aspects are highlighted, while others are not discussed in detail again, but may be present nonetheless. This embodiment constitutes a two chip solution with a flex-foil integration of a heating element and heat transfer barrier. This provide an option for a double sided flex foil, with heating on one side (or two separate flex foils).

This embodiment differs from the previous one in that the micro-fluidic cartridge can be bigger than the flex-foil covering the integrated circuits, and may only overlap with the detection chambers of the micro-fluidic cartridge. The micro-fluidic cartridge is closed by means of a closing film, which also spans over the full surface of the micro-fluidic cartridge body. The flex foil is attached to the cartridge body with the closing foil in-between and used to attach the integrated photodetector circuit and/or the integrated driver circuit.

The heating element HE is arranged in the flex foil FF. For example, the heating element comprises a heating coil. In this case, the closing foil and the flex foil FF are one (integrated) film. Furthermore, the flex foil is attached to the integrated photodetector circuit and driver circuit via an anisotropic conducting tape and contacts CT arranged in the foil. The foil comprises a number of optical windows, which align with the photodetectors. Alternatively, the optical windows can also be simply cutouts CU. When mounted to the integrated photodetector circuit and driver circuit, the cutouts define cavities aligned with the photodetectors and detection chambers. The flex foil may comprise or be made from an opaque material in order to reduce optical crosstalk.

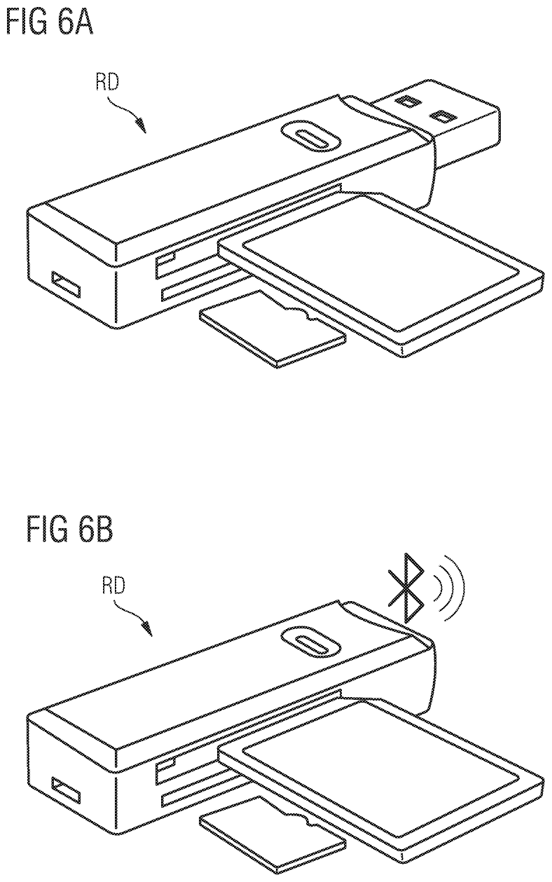

FIG. 6A and 6B shows an example embodiment of a micro-fluidic measuring device. The device comprises a micro-fluidic cartridge as discussed in the previous Figures. Furthermore, the device comprises a reader device, which has an opening to insert the micro-fluidic cartridge into a measurement position.

The micro-fluidic measuring device can be implemented to conduct a fluorescence based measurement or a chemo-luminescence based measurement. For the first type of measurement, the reader may be equipped with an excitation light source to illuminate the one or more detection chambers and/or a processing unit to control the light source. This way, the photodetectors may record fluorescence returning from the liquid in the detection chambers. In such case the photodetectors are equipped with the required optical filter arrangement to block the excitation light wavelength and detect the fluorescent wavelength.

Chemo-luminescence is the emission of light (luminescence) as the result of a chemical reaction. For the second type of measurement, the reader does not need to be equipped with a light source as no excitation may be needed to initiate luminescence. However, the micro-fluidic cartridge, i.e. micro-channels, can be used to insert chemical compounds to trigger chemical reactions, like test fluids as urine, saliva, blood, or derivate thereof, which initiate and yield a chemo-luminescent response. This may be controlled and/or processed by the processing unit. The reader device may be equipped to conduct one or both of the measurements discussed above. The reader may be arranged with a USB interface (FIG. 6A) or a wireless network interface, such as Bluetooth (FIG. 6B).

While this specification contains many specifics, these should not be construed as limitations on the scope of the improved concept or of what may be claimed, but rather as descriptions of features specific to particular embodiments of the improved concept. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

A number of implementations have been described. Nevertheless, various modifications may be made without departing from the spirit and scope of the improved concept. Accordingly, other implementations are within the scope of the claims.

### REFERENCE NUMERALS

BE backend
BW bond wire
CA carrier
CE cooling element
CF closing film
CH micro-channels
CT contacts in flex foil
CU cutouts in flex foil
DC detection chambers
DR driver circuit
FE frontend
FF flex foil
HE heating element
HS heat sink
MC micro-fluidic cartridge
PC integrated photodetector circuit
PD photodetector
SP1 surface
SP2 surface
VL vacuum layer

1. A micro-fluidic device, comprising:
an integrated photodetector circuit comprising at least one photodetector,
a micro-fluidic cartridge comprising at least one detection chamber connected to a micro-channel to receive a liquid to be tested, wherein the micro-fluidic cartridge is arranged on the integrated photodetector circuit such that the at least one detection chamber is aligned with the photodetector,
a heating element thermally conductive to the detection chamber and operable to alter a temperature of the liquid to be tested, and
a cooling element thermally conductive to the photodetector and operable to alter a temperature of the photodetector.

2. The device according to claim 1, wherein:
the micro-fluidic cartridge comprises multiple detection chambers which are connected to respective micro-channels to receive a liquid to be tested, and
the micro-fluidic cartridge is arranged on the integrated photodetector circuit such that detection chambers are aligned with the photodetectors.

3. The device according to claim 1, wherein the integrated photodetector circuit is arranged on and electrically connected to a flexible foil.

4. The device according to claim 3, wherein the flexible foil is arranged on the micro-fluidic cartridge and is operable to seal the micro-fluidic cartridge.

5. The device according to claim 1, wherein the integrated photodetector circuit is arranged on and electrically connected to a carrier.

6. The device according to claim 1, further comprising an integrated driver circuit, wherein
the integrated driver circuit is electrically connected to the integrated photodetector circuit, and
the integrated driver circuit is operable to control the micro-fluidic cartridge and/or the integrated photodetector circuit.

7. The device according to claim 6, wherein the integrated driver circuit and the integrated photodetector circuit are commonly arranged on and electrically connected to the flexible foil or to the carrier.

8. The device according to claim 1, wherein:
the heating element is arranged, in thermal contact, on a surface of the integrated photodetector circuit, or
the heating element is integrated into the integrated photodetector circuit.

9. The device according to claim 8, wherein the heating element comprises heater coils.

10. The device according to claim 1, wherein:
the cooling element is arranged, in thermal contact, on a surface of the integrated photodetector circuit, or
the cooling element is integrated into the integrated photodetector circuit.

11. The device according to claim 10, wherein the cooling element comprises a Peltier element.

12. The device according to claim 1, further comprising a heat barrier for one or more photodetectors.

13. The device according to claim 1, further comprising a cooling temperature sensor integrated into the integrated photodetector circuit, and/or wherein the cooling temperature sensor is operable to:
measure a temperature in a depletion zone of the photodetectors, or
measure a dark current of blinded photodetectors.

14. The device according to claim 1, further comprising a heater temperature sensor integrated into the integrated photodetector circuit, and/or wherein:
the heater temperature sensor is operable to measure a coil resistance as a function of temperature of the heating element, or
the heater temperature sensor comprises heat sensor elements which are operable to provide a temperature dependent signal.

15. A micro-fluidic measuring arrangement, comprising a micro-fluidic cartridge according to claim 1, and a reader device, wherein the reader device comprises an opening to insert the micro-fluidic cartridge into a measurement position.
